(19) United States
(12) Patent Application Publication
(10) Pub. No.: US 2012/0263372 A1
(43) Pub. Date: Oct. 18, 2012

(54) Method And Apparatus For Processing 3D Image

(75) Inventors: Mitsumasa Adachi, Gifu-shi (JP); Kentaro Suzuki, Chiba-shi (JP); Atsushi Moriwaki, Hiratsuka-shi (JP)

(73) Assignee: JVC KENWOOD Corporation, Kanagawa (JP)

(21) Appl. No.: 13/355,653

(22) Filed: Jan. 23, 2012

(30) Foreign Application Priority Data
Jan. 25, 2011 (JP) 2011-012813

(51) Int. Cl. G06K 9/36

(52) U.S. Cl. 382/154

(57) ABSTRACT

A first image and a second image make a stereo pair. A parallax between each subject image in the first image and a corresponding subject image in the second image is calculated. A 3D image formed by the first image and the second image is divided into a plurality of areas. Detection is made as to which of the areas each parallax calculated by the parallax calculator is present in. A desired parallax is determined on the basis of the calculated parallax or parallaxes present in one of the areas. An object image is superimposed on the first image and the second image in said one of the areas in a manner such that a parallax between the object image superimposed on the first image and the object image superimposed on the second image will be equal to the desired parallax.

### BACKGROUND OF THE INVENTION

1. Field of the Invention

This invention generally relates to a method and an apparatus for processing signals representing stereo-pair images for 3D (three dimensional) presentation. This invention particularly relates to a method and apparatus for properly indicating object pictures superimposed on stereo-pair images in response to a binocular parallax or disparity of each of areas constituting every 3D-presentation image frame.

2. Description of the Related Art

In 3D image technologies which have been developed in recent years, a pair of images having a binocular parallax or disparity therebetween in the horizontal direction are indicated on a single display as images for viewer's left and right eyes respectively and are actually observed by a viewer independently via viewer's left and right eyes respectively so that the viewer can perceive a subject indicated on the display as stereoscopic one.

A well-known 3D image technology is designed so that images for viewer's left and right eyes are linearly polarized and are perpendicular in direction of polarization, and are indicated on a single display on a superimposition basis. A viewer wears glasses with polarization filters which enable viewer's left and right eyes to independently observe the indicated left-eye and right-eye images respectively.

Another well-known 3D image technology is designed so that images for viewer's left eye and images for viewer's right eye are alternately indicated on a single display. A viewer wears glasses with liquid crystal shutters which alternately obstruct the sights of viewer's left and right eyes so that viewer's left and right eyes are allowed to independently observe the indicated left-eye and right-eye images respectively.

In these 3D image technologies, a horizontal-direction binocular parallax or disparity between images for viewer's left and right eyes determines the degree to which a subject picture in an indicated 3D image pops out or stands back relative to an indication plane (a screen plane) as observed by a viewer.

In some cases, a picture of characters representing time, a pictures of figures denoting various apparatus settings, or a menu picture for allowing a user to select the apparatus settings is superimposed on an indicated 3D image similarly to a usual indicated 2D (two dimensional) image. In the presence of a great difference between the degree to which such a picture pops out or stands back and the degree to which a subject picture does, viewer's eyes are subject to considerable stresses so that the viewer tends to feel sick and suffer from fatigue of the eyes. An example of the above cases is that a subject picture greatly pops out while a character picture near the subject picture extremely stands back.

Techniques of superimposing a character picture or a similar picture on an indicated 3D image without imposing stresses to viewer's eyes have briskly been developed.

For example, International patent application publication number WO 2008/115222 corresponding to Japanese patent application publication number 2010-521738 discloses a system for combining text with 3D content, and specifically inserting the text at the same level as the highest depth value in the 3D content.

Japanese patent application publication number 2010-130495 discloses a 3D information outputting apparatus designed so that a horizontal-direction positional difference in content between an image for viewer's left eye and an image for viewer's right eye is detected as a representation of a stereoscopic degree. The detection of the positional difference is based on captions or telops in the images, or motion vectors between the images. Left-eye menu display data and right-eye menu display data are generated in response to the detected positional difference (the stereoscopic degree). Left-eye menu picture and right-eye menu picture represented by the left-eye menu display data and the right-eye menu display data are superimposed on the left-eye image and the right-eye image, respectively. Thus, a resultant menu picture is indicated on a 3D basis also.

In the system of International application WO 2008/115222, the text is always observed as that at the deepest place in the indicated 3D image. Thus, in the case of a text-added indicated 3D image has a subject picture greatly popping out, there is a large difference in 3D feeling between the text and the subject picture. Such a large difference may impose considerable stresses on viewer's eyes.

The apparatus of Japanese application 2010-130495 does not consider the relation between an area assigned to the indication of the menu picture and an image area used for the detection of the positional difference (the stereoscopic degree). Accordingly, there is a chance that the menu picture greatly pops out while a subject picture not used for the detection of the positional difference extremely stands back. In this case, considerable stresses may be imposed on viewer's eyes.

### SUMMARY OF THE INVENTION

It is an object of this invention to provide a method of processing signals of stereo-pair images which can adjust the degree to which an object picture pops out or stands back in accordance with a binocular parallax or disparity in each of areas constituting one or every 3D-presentation image frame. The object picture is, for example, a text, a figure, or a menu picture having a combination of a text and a figure.

It is another object of this invention to provide an apparatus for processing signals of stereo-pair images which can adjust the degree to which an object picture pops out or stands back in accordance with a binocular parallax or disparity in each of areas constituting one or every 3D-presentation image frame.

A first aspect of this invention provides a 3D image processing apparatus comprising a recording section configured to record data representative of a first image and data representative of a second image; an object image store section configured to store data representative of an object image to be superimposed on the first image and the second image; a parallax calculator configured to calculate a parallax between each subject image in the first image and a corresponding subject image in the second image; a parallax existence area detector configured to divide a 3D image formed by the first image and the second image into a plurality of areas, and detect which of the areas each parallax calculated by the parallax calculator is present in; a parallax decider configured to determine a desired parallax between the object image to be superimposed on the first image in one of the areas and the object image to be superimposed on the second image in said one of the areas on the basis of the calculated parallax or parallaxes present in said one of the areas; an object image superimposer configured to superimpose the object image on the first image and the second image in said one of the areas in a manner such that a parallax between the object image superimposed on the first image and the object image superimposed on the second image will be equal to the desired parallax determined by the parallax decider; and an output section configured to output the first image with the superimposed object image and the second image with the superimposed object image as a 3D image.

A second aspect of this invention is based on the first aspect thereof, and provides a 3D image processing apparatus wherein the parallax decider determines the desired parallax so that the desired parallax will be equal to the greatest of the calculated parallaxes present in said one of the areas.

A third aspect of this invention is based on the first aspect thereof, and provides a 3D image processing apparatus wherein the parallax decider determines the desired parallax so that the desired parallax will be equal to the greatest of the calculated parallaxes present in said one of the areas in cases where the greatest of the calculated parallaxes corresponds to a popping-out subject image, and the parallax decider determines the desired parallax so that the desired parallax will be equal to zero or the greatest of the calculated parallaxes present in said one of the areas in cases where the greatest of the calculated parallaxes corresponds to a standing-back subject image.

A fourth aspect of this invention is based on the third aspect thereof, and provides a 3D image processing apparatus wherein the parallax existence area detector divides the 3D image formed by the first image and the second image into at least two areas in a horizontal direction or a vertical direction.

A fifth aspect of this invention provides a method of processing 3D image. The method comprises the steps of recording data representative of a first image and data representative of a second image; calculating a parallax between each subject image in the first image and a corresponding subject image in the second image; dividing a 3D image formed by the first image and the second image into a plurality of areas; detecting which of the areas each calculated parallax is present in; determining a desired parallax between an object image to be superimposed on the first image in one of the areas and the object image to be superimposed on the second image in said one of the areas on the basis of the calculated parallax or parallaxes present in said one of the areas; superimposing the object image on the first image and the second image in said one of the areas in a manner such that a parallax between the object image superimposed on the first image and the object image superimposed on the second image will be equal to the desired parallax; and outputting the first image with the superimposed object image and the second image with the superimposed object image as a 3D image.

A sixth aspect of this invention is based on the fifth aspect thereof, and provides a method wherein the determining step comprises determining the desired parallax so that the desired parallax will be equal to the greatest of the calculated parallaxes present in said one of the areas.

A seventh aspect of this invention is based on the fifth aspect thereof, and provides a method wherein the determining step comprises determining the desired parallax so that the desired parallax will be equal to the greatest of the calculated parallaxes present in said one of the areas in cases where the greatest of the calculated parallaxes corresponds to a popping-out subject image, and determining the desired parallax so that the desired parallax will be equal to zero or the greatest of the calculated parallaxes present in said one of the areas in cases where the greatest of the calculated parallaxes corresponds to a standing-back subject image.

An eighth aspect of this invention is based on the seventh aspect thereof, and provides a method wherein the dividing step comprises dividing the 3D image formed by the first image and the second image into at least two areas in a horizontal direction or a vertical direction.

This invention has the following advantage. In the case where an object picture is superimposed on indicated 3D images, the degree to which the object picture pops out or stands back can be adjusted in accordance with a binocular parallax or disparity in each of areas constituting one or every 3D image frame.

### BRIEF DESCRIPTION OF THE DRAWINGS

FIG. 1 is a block diagram of an imaging apparatus according to an embodiment of this invention.

FIG. 2 is a diagram of a liquid-crystal monitor in FIG. 1 and viewer's eyes.

FIG. 3 is a diagram of an example of a captured image indicated on the liquid-crystal monitor in FIGS. 1 and 2 which has superimposed object pictures.

FIG. 4(a) is a diagram showing an example of the relation among the positions of stereo-pair object pictures and viewer's eyes where a resultant object picture is perceived as a popping-out picture.

FIG. 4(b) is a diagram showing an example of the relation among the positions of stereo-pair object pictures and viewer's eyes where a resultant object picture is perceived as one located at a screen plane.

FIG. 4(c) is a diagram showing an example of the relation among the positions of stereo-pair object pictures and viewer's eyes where a resultant object picture is perceived as a standing-back picture.

FIG. 5 is a flowchart of a segment of a control program for a CPU in FIG. 1 which relates to a process of superimposing object pictures on stereo-pair images.

FIG. 6 is a diagram showing left-eye and right-eye captured images, subject pictures therein, and positional-difference vectors between the subject pictures.

FIG. 7 is a diagram showing left-eye and right-eye captured images, subject pictures therein, positional-difference vectors between the subject pictures, and areas resulting from dividing each of the left-eye and right-eye captured images in the vertical direction.

FIG. 8 is a diagram showing left-eye and right-eye captured images, subject pictures therein, positional-difference vectors between the subject pictures, and areas resulting from dividing each of the left-eye and right-eye captured images in the horizontal direction.

FIG. 9 is a diagram showing a 3D-presentation image frame divided into a left-hand area and a right-hand area, and positional-difference vectors each having one portion contained in the left-hand area and the other portion contained in the right-hand area.

FIG. 10 is a diagram showing left-eye and right-eye captured images, subject pictures therein, positional-difference vectors between the subject pictures, and areas resulting from dividing each of the left-eye and right-eye captured images in the vertical direction and the horizontal direction.

FIG. 11 is a diagram showing a 3D-presentation image frame divided into upper-left, upper-right, lower-left, and lower-right areas, and positional-difference vectors in the upper-left area.

FIG. 12 is a diagram showing an original object picture, left-eye and right-eye object pictures resulting from shifting the original object picture, and left-eye and right-eye captured images on which the left-eye and right-eye object pictures are superimposed respectively where a resultant object picture is perceived as a popping-out picture.

FIG. 13 is a diagram showing an original object picture, left-eye and right-eye object pictures resulting from shifting the original object picture, and left-eye and right-eye captured images on which the left-eye and right-eye object pictures are superimposed respectively where a resultant object picture is perceived as a standing-back picture.

### DETAILED DESCRIPTION OF THE INVENTION

A 3D (three dimensional) image processing apparatus in an embodiment of this invention will be described below with reference to drawings. In the following description and drawings, elements having substantially the same functions and structures are denoted by the same reference characters. Duplicate explanations of these elements will be avoided. Illustrations of elements having no direct relation with this invention will be omitted from the drawings.

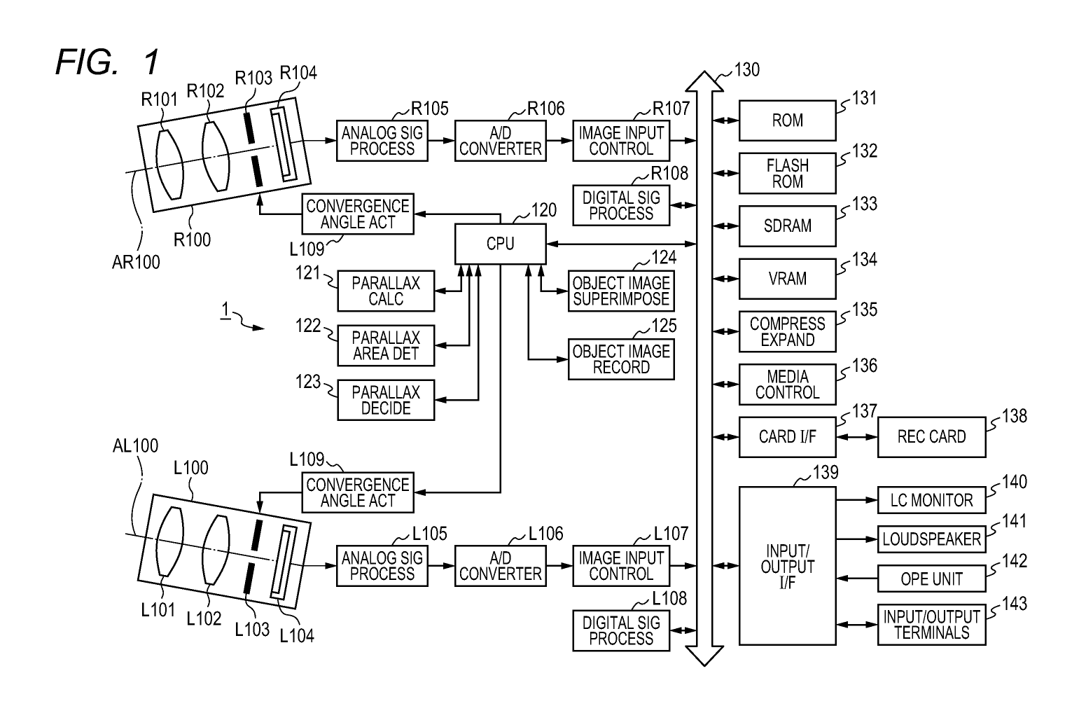

FIG. 1 shows an imaging apparatus or a digital video camera 1 including the 3D image processing apparatus in the embodiment of this invention. The imaging apparatus 1 can take or capture moving pictures or sill pictures.

The imaging apparatus 1 has two imaging sections designed so that an angle of convergence formed by the optical axes of the imaging sections can be adjusted.

This invention can also be applied to an imaging apparatus having two imaging sections designed so that the optical axes of the imaging sections are fixed and angles of convergence can not be adjusted. Furthermore, this invention can be applied to a digital still camera, a mobile camera phone, a camera-added PHS (Personal Handyphone System) device, a camera-added PDA (Personal Digital Assistant) device, or an electronic device equipped with a camera.

The imaging apparatus 1 includes a CPU 120 for controlling operation of the whole of the imaging apparatus 1 that relates to an imaging action, a displaying action, a recording action, and other actions. The CPU 120 controls, in response to signals inputted via an operation unit 142, sections of the imaging apparatus 1 according to a prescribed control program (computer program).

The imaging apparatus 1 has a pair of an imaging section L100 for a left eye and an imaging section R100 for a right eye. The left-eye imaging section L100 and the right-eye imaging section R100 are spaced at an interval slightly shorter than a normal interval between human left and right eyes. The interval between the two sections L100 and R100 is equal to, for example, 6.25 cm.

The left-eye imaging section L100 includes a zoom lens L101, a focus lens L102, an aperture stop L103, and a solid-state image sensor L104 successively arranged in a direction of travel of incoming light. Similarly, the right-eye imaging section R100 includes a zoom lens R101, a focus lens R102, an aperture stop R103, and a solid-state image sensor R104 successively arranged in a direction of travel of incoming light.

The left-eye imaging section L100 has an optical axis AL100 along which the zoom lens L101 can be moved by a zoom actuator (not shown). The right-eye imaging section R100 has an optical axis AR100 along which the zoom lens R101 can be moved by a zoom actuator (not shown).

The focus lens L102 can be moved by a focus actuator (not shown) along the optical axis AL100. The focus lens R102 can be moved by a focus actuator (not shown) along the optical axis AR100. The aperture stops L103 and R103 can be driven by stop actuators (not shown), respectively.

The left-eye imaging section L100 and the right-eye imaging section R100 are connected with convergence angle actuators L109 and R109, respectively. The convergence angle actuators L109 and R109 drive the two sections L100 and R100 in response to commands from the CPU 120 to adjust a convergence angle formed between the optical axes AL100 and AR100.

A ROM 131 is connected with the CPU 120 via a bus 130. The ROM 131 stores the control program executed by the CPU 120 and various types of data used for the control by the CPU 120. A flash ROM 132 connected to the bus 130 stores setting information of a user and various types of setting information relating to operation of the imaging apparatus 1.

Operation of the imaging apparatus 1 can be changed among different modes including various image capturing modes such as a still-image capturing mode for taking a still image or images and a moving-image capturing mode for taking moving images. Various types of setting information relating to the still-image capturing mode and the moving-image capturing mode are stored in the flash ROM 132.

An SDRAM 133 connected to the bus 130 is used as an operation work area for the CPU 120. In addition, the SDRAM 133 is used as a temporarily storage area for image data. The SDRAM 133 serves as a recording section for data representing stereo-pair images. A VRAM 134 connected to the bus 130 is used as a temporarily storage area for image data to be indicated.

The imaging apparatus 1 takes or captures a pair or every pair (stereo-pair) of images for 3D presentation as follows. Image-representing light for viewer's left eye is applied to the left-eye image sensor L104 after passing through the zoom lens L101, the focus lens L102, and the aperture stop L103. The left-eye image sensor L104 subjects the applied light to photoelectric conversion to generate an analog signal representative of a captured image for viewer's left eye. Similarly, image-representing light for viewer's right eye is applied to the right-eye image sensor R104 after passing through the zoom lens R101, the focus lens R102, and the aperture stop R103. The right-eye image sensor R104 subjects the applied light to photoelectric conversion to generate an analog signal representative of a captured image for viewer's right eye.

An image for viewer's left eye is referred to as a left-eye image also. Similarly, an image for viewer's right eye is referred to as a right-eye image also.

An analog signal processor L105 receives the analog image signal from the left-eye image sensor L104, and amplifies the received analog signal. An A/D converter L106 receives the amplified analog signal from the analog signal processor L105, and converts the received analog signal into digital data (a digital signal) representative of the captured image for viewer's left eye. An image input controller L107 connected between the A/D converter L106 and the bus 130 receives the left-eye digital data from the A/D converter L106, and stores the received digital data into the SDRAM 133.

Similarly, an analog signal processor R105 receives the analog image signal from the right-eye image sensor R104, and amplifies the received analog signal. An A/D converter R106 receives the amplified analog signal from the analog signal processor R105, and converts the received analog signal into digital data (a digital signal) representative of the captured image for viewer's right eye. An image input controller R107 connected between the A/D converter R106 and the bus 130 receives the right-eye digital data from the A/D converter R106, and stores the received digital data into the SDRAM 133.

A digital signal processor L108 connected to the bus 130 responds to a command from the CPU 120 to implement the following action. The digital signal processor L108 fetches the left-eye digital data from the SDRAM 133 and subjects the fetched digital data to prescribed signal processing to generate a digital image signal composed of a luminance signal and color difference signals representing the captured image for viewer's left eye. The digital signal processor L108 subjects the fetched digital data to digital-based various correction processes such as an offset process, a white balance adjustment process, a gamma correction process, an RGB complement process, a noise reduction process, an edge correction process, a color tone correction process, and a light-source decision process. The digital signal processor L108 stores the correction-resultant left-eye image data into the SDRAM 133.

Similarly, a digital signal processor R108 connected to the bus 130 responds to a command from the CPU 120 to implement the following action. The digital signal processor R108 fetches the right-eye digital data from the SDRAM 133 and subjects the fetched digital data to prescribed signal processing to generate a digital image signal composed of a luminance signal and color difference signals representing the captured image for viewer's right eye. The digital signal processor L108 subjects the fetched digital data to digital-based various correction processes such as an offset process, a white balance adjustment process, a gamma correction process, an RGB complement process, a noise reduction process, an edge correction process, a color tone correction process, and a light-source decision process. The digital signal processor R108 stores the correction-resultant right-eye image data into the SDRAM 133.

A compression expansion processor 135, a media controller 136, a card interface (I/F) 137, and an input output I/F 139 are connected to the bus 130.

The compression expansion processor 135 compresses image data in the SDRAM 133 to generate compressed image data of a prescribed format in response to a command from the CPU 120. The compression expansion processor 135 expands compressed image data of a prescribed format in a recording card (a card-shaped recording medium) 138 connected with the card I/F 137 to generate non-compressed image data.

For still image data, the compression by the compression expansion processor 135 conforms to the JPEG standards. For moving image data, the compression by the compression expansion processor 135 conforms to the MPEG2 standards or the AVC/H.264 standards.

The media controller 136 controls the writing of image data into the recording card 138 via the card I/F 137 in response to a command from the CPU 120. In addition, the media controller 136 controls the readout of image data from the recording card 138 via the card I/F 137 in response to a command from the CPU 120.

A parallax calculator 121, a parallax-existence-area detector 122, a parallax decider 123, an object image (picture) superimposer 124, and an object image (picture) recorder 125 are connected with the CPU 120. The devices 121-125 cooperate to superimpose stereo-pair object pictures on stereo-pair images while being controlled by the CPU 120.

The object picture recorder 125 serves as an object image store section. Specifically, the object picture recorder 125 stores previously-recorded data representative of various object pictures to be superimposed on captured images or other images, and previously-recorded information representative of positions (on-frame positions) at which the object pictures should be superimposed. For example, the previously-recorded data has a piece representative of a first figure designed to visually indicate that the imaging apparatus 1 is operating in the still-image capturing mode or the moving-image capturing mode, and a piece representative of a second figure designed to visually indicate a remaining power in a battery (not shown) within the imaging apparatus 1. For example, the previously-recorded information has a piece representative of a superimposing position for the above first figure in 2D (two dimensional) presentation, a piece representative of a superimposing position for the above first figure in 3D presentation, a piece representative of a superimposing position for the above second figure in 2D presentation, and a piece representative of a superimposing position for the above second figure in 3D presentation.

A liquid-crystal monitor 140, a loudspeaker or loudspeakers 141, the operation unit 142, and input output terminals 143 are connected with the input output I/F 139.

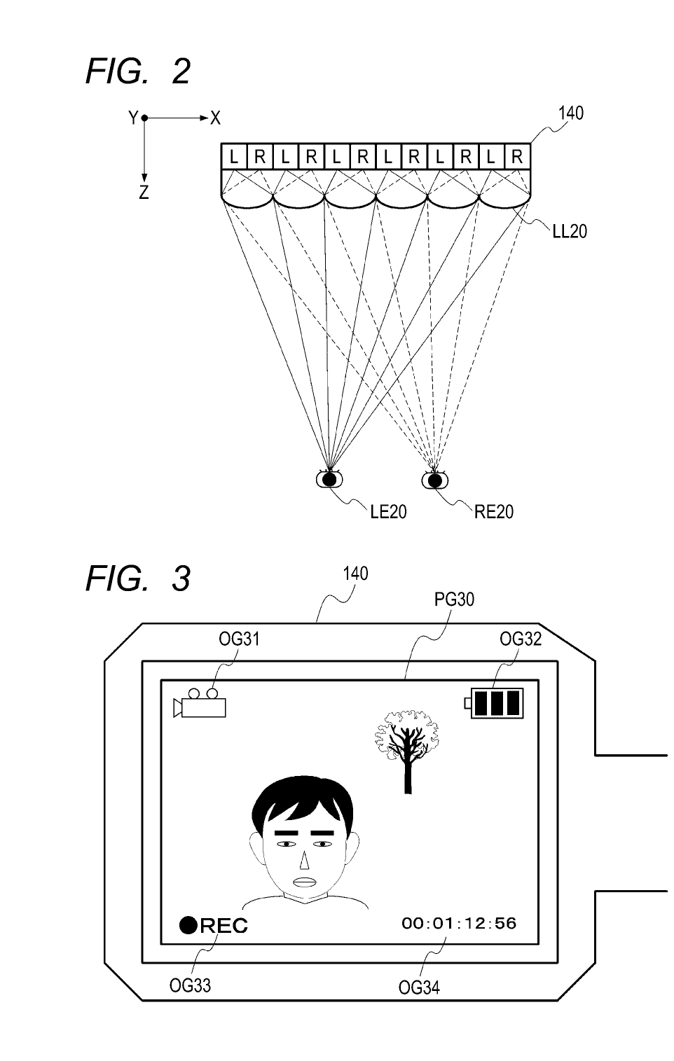

With reference to FIG. 2, an X axis, a Y axis, and a Z axis defined with respect to the liquid-crystal monitor 140 are parallel to the horizontal direction, the vertical direction, and the direction perpendicular to the monitor screen respectively when the imaging apparatus 1 assumes its normal posture.

The liquid-crystal monitor 140 is provided with a lenticular lens LL20 in front of the monitor screen. The lenticular lens LL20 is located between the monitor screen and viewer's left eye LE20 and viewer's right eye RE20. The lenticular lens LL20 has a series of cylindrical convex lenses arranged in the direction of the X axis of FIG. 2.

The entire display area for a 3D image indicated on the liquid-crystal monitor 140 consists of strip-shaped display areas L for viewer's left eye LE20 and strip-shaped display areas R for viewer's right eye RE20. The strip-shaped display areas L and R elongate in the direction of the Y axis of FIG. 2. The strip-shaped display areas L and the strip-shaped display areas R are alternately arranged in the direction of the X axis of FIG. 2.

Each of the cylindrical convex lenses constituting the lenticular lens LL20 is positioned to cover a pair of a left-eye strip-shaped display area L and a right-eye strip-shaped display area R adjacent to each other while a prescribed observation point of a viewer is taken as a reference.

The curvatures and other characteristics of the cylindrical convex lenses constituting the lenticular lens LL20 are chosen so that a left-eye image composed of segments indicated on the left-eye strip-shaped display areas L of the liquid-crystal monitor 140 will be applied to viewer's left eye LE20 while a right-eye image composed of segments indicated on the right-eye strip-shaped display areas R of the liquid-crystal monitor 140 will be applied to viewer's right eye RE20.

Accordingly, viewer's left eye LE20 observes the left-eye image only and viewer's right eye RE20 observes the right-eye image only so that the viewer can perceive the images indicated on the liquid-crystal monitor 140 as a 3D image.

The liquid-crystal monitor 140 may be of another 3D type such as a parallax barrier type or a light-direction control type.

Operation of the liquid-crystal monitor 140 can be changed among modes including a 3D mode, a first 2D mode, and a second 2D mode. During the 3D mode of operation, the liquid-crystal monitor 140 indicates a pair of left-eye and right-eye images to a viewer as a 3D image. During the first 2D mode of operation, the liquid-crystal monitor 140 indicates a left-eye image or a right-eye image only. During the second 2D mode of operation, the liquid-crystal monitor 140 indicates a left-eye image and a right-eye image to a viewer on a side-by-side basis.

The operation unit 142 can be actuated by the user or the viewer. The operation unit 142 has a joystick, a cross key, and operation keys including a release switch, a power supply switch, and a recording button. The operation unit 142 may further contain a touch panel superimposed on the liquid-crystal monitor 140. In addition, the operation unit 142 may contain other buttons. The operation unit 142 receives user's or viewer's commands for operation of the imaging apparatus 1.

The input output terminals 143 are connected to, for example, a PC (Personal Computer) and an external monitor (not shown). The external monitor may be a television monitor.

With reference to FIG. 3, the imaging apparatus 1 indicates a captured image PG30 on the liquid-crystal monitor 140 as a through-the-lens image or an image that is being recorded. There are examples of object pictures superimposed on the indicated image PG30.

In FIG. 3, the indicated image PG30 on the liquid-crystal monitor 140 is a 2D image taken by the left-eye imaging section L100 or the right-eye imaging section R100. Object pictures may be superimposed on a pair or every pair of left-eye and right-eye images indicated on the liquid-crystal monitor 140.

As previously mentioned, operation of the imaging apparatus 1 can be changed among different modes including the still-image capturing mode and the moving-image capturing mode. An object picture OG31 superimposed on the indicated image PG30 denotes that the imaging apparatus 1 is operating in the moving-image capturing mode. An object picture OG32 superimposed on the indicated image PG30 denotes a remaining power in the battery (not shown). An object picture OG33 superimposed on the indicated image PG30 denotes that the recording button in the operation unit 42 has been depressed by the user and the imaging apparatus 1 has started capturing images and recording the captured images. An object picture OG34 superimposed on the indicated image PG30 denotes the elapsed time for which the recording of captured images has been continued.

Signals or data pieces representative of the object pictures OG31-OG34 are stored in the object picture recorder 125. The CPU 120 transfers these data pieces from the object picture recorder 125 to the liquid-crystal monitor 140 via the bus 130 and the input output I/F 139 or to the external monitor via the bus 130, the input output I/F 139, and the input output terminals 143. The CPU 120 controls the transferred data pieces so that the object pictures OG31-OG34 will be indicated on the liquid-crystal monitor 140 or the external monitor in a 2D basis or a 3D basis depending on whether a main indicated image (the indicated image PG30) is of the 2D type or the 3D type.

Information pieces representative of positions at which the object pictures OG31-OG34 should be superimposed are stored in the object picture recorder 125. The CPU 120 determines the actual positions of the object pictures OG31-OG34 relative to the main indicated image (the indicated image PG30) in accordance with the positions represented by these information pieces in the object picture recorder 125.

The imaging apparatus 1 can indicate other object pictures on the liquid-crystal monitor 140 or the external monitor at positions represented by related information pieces in the object picture recorder 125.

Regarding object pictures or subject pictures in left-eye and right-eye images indicated on the liquid-crystal monitor 140 or the external monitor connected with the input output terminals 143, a description will be given below of the relation of the parallax between the left-eye and right-eye images with the degree to which a 3D object or subject picture pops out or stands back.

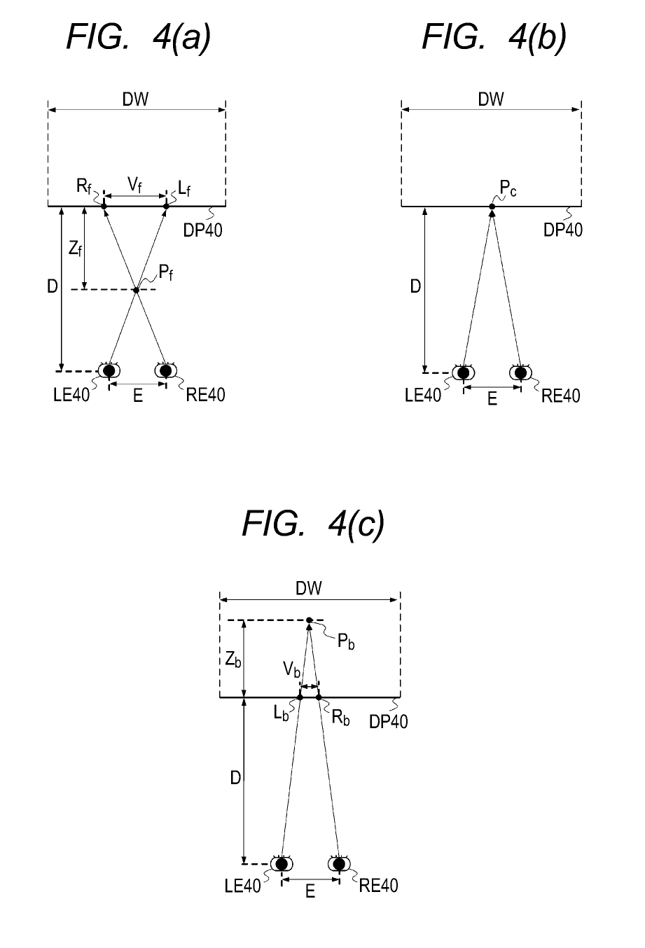

With reference to FIGS. 4(a), 4(b), and 4(c), “DP40” denotes the screen plane of the liquid-crystal monitor 140 or the external monitor and “D” denotes the distance between a viewer and the screen plane DP40, and “E” denotes the distance between the left eye LE40 and the right eye RE40 of the viewer.

In FIG. 4(a), “Lf” denotes the position of a subject picture (or an object picture) in the left-eye image on the screen plane DP40, and “Rf” denotes the position of a corresponding subject picture in the right-eye image on the screen plane DP40. The position Lf exists rightward of the position Rf as seen from the viewer. When viewer's left eye LE40 observes the subject picture at the position Lf and viewer's right eye RE40 observes the subject picture at the position Rf, light from the subject picture at the position Lf and light from the subject picture at the position Rf form a resultant picture at a position Pf in front of the screen plane DP40. Thus, in a main indicated 3D image, the viewer perceives the resultant picture as one popping out from the screen plane DP40.

At this time, the distance Zf from the screen plane DP40 to the picture formation position Pf is given by the following equation.

(E+Vf)Zf=D·Vf (1)

where Vf denotes the parallax between the subject picture at the position Lf and the subject picture at the position Rf.

With reference to FIG. 4(b), when the position of a subject picture (or an object picture) in the left-eye image and the position of a corresponding subject picture in the right-eye image are the same on the screen plane DP40, a resultant picture is formed at a position Pc on the screen plane DP40. Thus, in a main indicated 3D image, the viewer perceives the resultant picture as one existing on the screen plane DP40.

In FIG. 4(c), “Lb” denotes the position of a subject picture (or an object picture) in the left-eye image on the screen plane DP40, and “Rb” denotes the position of a corresponding subject picture in the right-eye image on the screen plane DP40. The position Lb exists leftward of the position Rb as seen from the viewer. When viewer's left eye LE40 observes the subject picture at the position Lb and viewer's right eye RE40 observes the subject picture at the position Rb, light from the subject picture at the position Lb and light from the subject picture at the position Rb virtually form a resultant picture at a position Pb behind the screen plane DP40. Thus, in a main indicated 3D image, the viewer perceives the resultant picture as one standing back from the screen plane DP40.

At this time, the distance Zb from the screen plane DP40 to the picture formation position Pb is given by the following equation.

(E−Vb)Zb=D·Vb (2)

where Vb denotes the parallax between the subject picture at the position Lb and the subject picture at the position Rb.

As explained above, the parallax between subject pictures or object pictures in left-eye and right-eye images for 3D presentation affects the degree to which a resultant subject or object picture pops out or stands back.

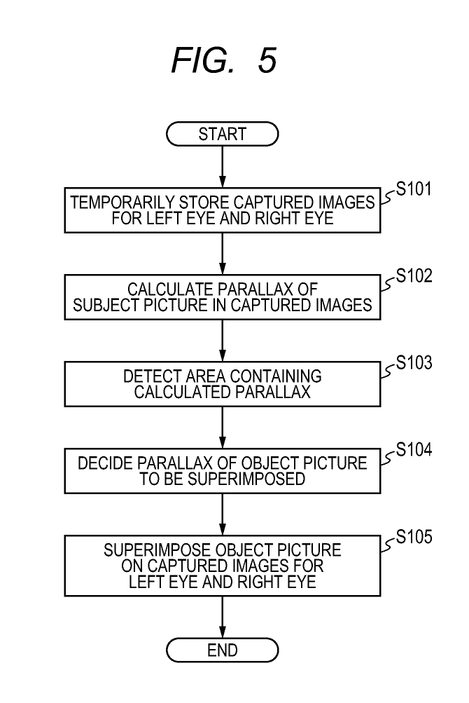

FIG. 5 is a flowchart of a segment of the control program for the CPU 120 which enables the imaging apparatus 1 to superimpose object pictures on stereo-pair images for 3D presentation. Specifically, for the superimposition, the imaging apparatus 1 divides a 3D-presentation image frame into a plurality of areas and detects the degree to which a subject picture pops out or stands back for each of the areas, and superimposes object pictures on the stereo-pair images in response to the detected degrees.

Preferably, the program segment in FIG. 5 is executed for every stereo-pair of left-eye and right-eye captured images.

When a user depresses the recording button in the operation unit 142, the program segment in FIG. 5 is started by a main routine of the control program for the CPU 120. The program segment in FIG. 5 may be started with respect to through-the-lens images occurring when the user turns on power to the imaging apparatus 1 and then selects the still-image capturing mode or the moving-image capturing mode by actuation of the operation unit 142 or half depresses the recording button.

As shown in FIG. 5, a first step S101 of the program segment temporarily stores, in the SDRAM 133, left-eye image data (data representative of an image for viewer's left eye which is taken by the left-eye imaging section L100) and right-eye image data (data representative of an image for viewer's right eye which is taken by the right-eye imaging section R100).

A step S102 following the step S101 controls the parallax calculator 121 to calculate a parallax between subject pictures in the stereo-pair images represented by the left-eye image data and the right-eye image data in the SDRAM 133.

Preferably, the parallax calculator 121 applies, to the parallax calculation, an MPEG algorithm for detecting or calculating motion vectors between successive frames which can represent the distance and direction of movement of a same subject (a common subject). The MPEG algorithm detects motion vectors based on block matching. Motion vectors can indicate a displacement of a same subject between two successive frames.

According to the motion-vector-calculating MPEG algorithm, every frame is divided into blocks. Image data pieces for the respective blocks in a current frame and image data pieces for the respective blocks in a previous frame are compared to implement block matching and thereby find pairs of the most like blocks. Motion vectors are calculated from the relation between the positions of the most like blocks in each pair.

The parallax calculator 121 uses the motion-vector-calculating MPEG algorithm to detect a same subject picture (a common subject picture) in the stereo-pair images represented by the left-eye image data and the right-eye image data. The parallax calculator 121 computes the positional difference between the subject picture in the left-eye image and the subject picture in the right-eye image at a resolution corresponding to one point or one pixel. The parallax calculator 121 labels the horizontal-direction component of a vector of the computed positional difference as a parallax between the subject pictures in the left-eye and right-eye images.

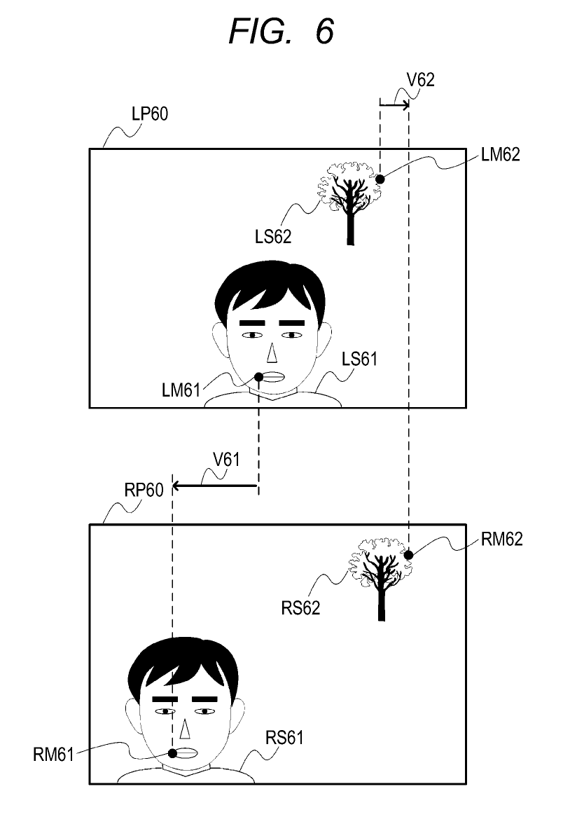

With reference to FIG. 6, there is a stereo-pair of a left-eye captured image LP60 and a right-eye captured image RP60. As a result of the block matching, the parallax calculator 121 detects or decides that a subject picture LS61 in the left-eye captured image LP60 and a subject picture RS61 in the right-eye captured image RP60 are the same, and that a subject picture LS62 in the left-eye captured image LP60 and a subject picture RS62 in the right-eye captured image RP60 are the same. Subsequently, the parallax calculator 121 selects a base point (or pixel) LM61 in the subject picture LS61 and a base point (or pixel) LM62 in the subject picture LS62. Then, the parallax calculator 121 detects, in the subject picture RS61, a point (or pixel) RM61 corresponding to the base point LM61. Similarly, the parallax calculator 121 detects, in the subject picture RS62, a point (or pixel) RM62 corresponding to the base point LM62. Thereafter, the parallax calculator 121 computes a vector of the positional difference between the base point LM61 and the corresponding point RM61. The computed vector starts from the base point LM61 and ends at the corresponding point RM61. The parallax calculator 121 uses the horizontal-direction component V61 of the computed vector as a representation of the parallax between the subject pictures LS61 and RS61. Furthermore, the parallax calculator 121 computes a vector V62 of the positional difference between the base point LM62 and the corresponding point RM62. The computed vector starts from the base point LM62 and ends at the corresponding point RM62. The parallax calculator 121 uses the horizontal-direction component V62 of the computed vector as a representation of the parallax between the subject pictures LS62 and RS62.

The parallax calculator 121 may select a base point (or pixel) in the subject picture RS61 and a base point (or pixel) in the subject picture RS62 in the right-eye captured image RP60. In this case, the parallax calculator 121 detects, in the subject picture LS61 in the left-eye captured image LP60, a point (or pixel) corresponding to the base point in the subject picture RS61. Similarly, the parallax calculator 121 detects, in the subject picture LS62 in the left-eye captured image LP60, a point (or pixel) corresponding to the base point in the subject picture RS62. Thereafter, the parallax calculator 121 computes a vector of the positional difference between the base point in the subject picture RS61 and the corresponding point in the subject picture LS61. The parallax calculator 121 uses the horizontal-direction component of the computed vector as a representation of the parallax between the subject pictures LS61 and RS61. Furthermore, the parallax calculator 121 computes a vector of the positional difference between the base point in the subject picture RS62 and the corresponding point in the subject picture LS62. The parallax calculator 121 uses the horizontal-direction component of the computed vector as a representation of the parallax between the subject pictures LS62 and RS62.

The horizontal-direction component of each vector computed by the parallax calculator 121 is referred to as the computed positional-difference vector also.

With reference back to FIG. 5, a step S103 following the step S102 controls the parallax-existence-area detector 122 to divide a 3D-presentation image frame into a plurality of areas and to decide which of the areas each computed positional-difference vector is contained in.

The frame division is of a type which can be selected from first, second, and third types. According to the first type, a 3D-presentation image frame is divided into two areas in the vertical direction. According to the second type, a 3D-presentation image frame is divided into two areas in the horizontal direction. According to the third type, a 3D-presentation image frame is divided into four areas or 2-by-2 areas (that is, two areas in the horizontal direction by two areas in the vertical direction). Preferably, the parallax-existence-area detector 122 selects one from the first, second, and third types in response to the number of object pictures to be superimposed and the positions at which the object pictures should be indicated. Then, the parallax-existence-area detector 122 implements the frame division of the selected type.

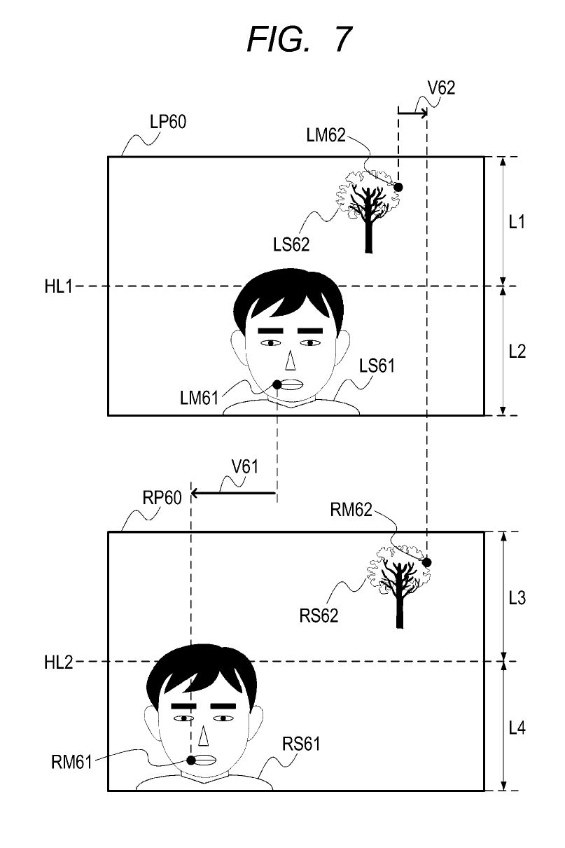

In the case of dividing a 3D-presentation image frame into two areas in the vertical direction, the parallax-existence-area detector 122 operates as follows. With reference to FIG. 7, the parallax-existence-area detector 122 processes the left-eye image data in the SDRAM 133 to divide the left-eye captured image LP60 into upper and lower areas along a horizontal line HL1. Similarly, the parallax-existence-area detector 122 processes the right-eye image data in the SDRAM 133 to divide the right-eye captured image RP60 into upper and lower areas along a horizontal line HL2.

Preferably, the ROM 131 previously stores reference data representing a prescribed ratio in size between the upper and lower areas in each of the left-eye and right-eye captured images LP60 and RP60, that is, a prescribed ratio between the vertical length L1 of the upper area and the vertical length L2 of the lower area in the left-eye captured image LP60 and a prescribed ratio between the vertical length L3 of the upper area and the vertical length L4 of the lower area in the right-eye captured image RP60. The prescribed ratio is equal to, for example, 5:5. The parallax-existence-area detector 122 refers to the reference data in the ROM 131, and sets the actual ratio in size between the upper and lower areas in each of the left-eye and right-eye captured images LP60 and RP60 to the prescribed ratio represented by the reference data.

The CPU 120 may control the parallax-existence-area detector 122 to vary the actual ratio in size between the upper and lower areas in each of the left-eye and right-eye captured images LP60 and RP60 in accordance with actuation of a button in the operation unit 142 by the user or the viewer. The CPU 120 may control the parallax-existence-area detector 122 to vary the actual ratio in accordance with the number of object pictures to be superimposed or which of the image capturing modes the imaging apparatus 1 is operating in.

With reference to FIG. 7, the parallax-existence-area detector 122 decides which of the upper and lower areas in the stereo-pair images LP60 and RP60 each of the positional-difference vectors V61 and V62 is contained in. Then, the parallax-existence-area detector 122 concludes that the positional-difference vector V61 between the base point LM61 in the subject picture LS61 in the left-eye captured image LP60 and the corresponding point RM61 in the subject picture RS61 in the right-eye captured image RP60 exists in the lower areas of the stereo-pair images LP60 and RP60. Furthermore, the parallax-existence-area detector 122 concludes that the positional-difference vector V62 between the base point LM62 in the subject picture LS62 in the left-eye captured image LP60 and the corresponding point RM62 in the subject picture RS62 in the right-eye captured image RP60 exists in the upper areas of the stereo-pair images LP60 and RP60.

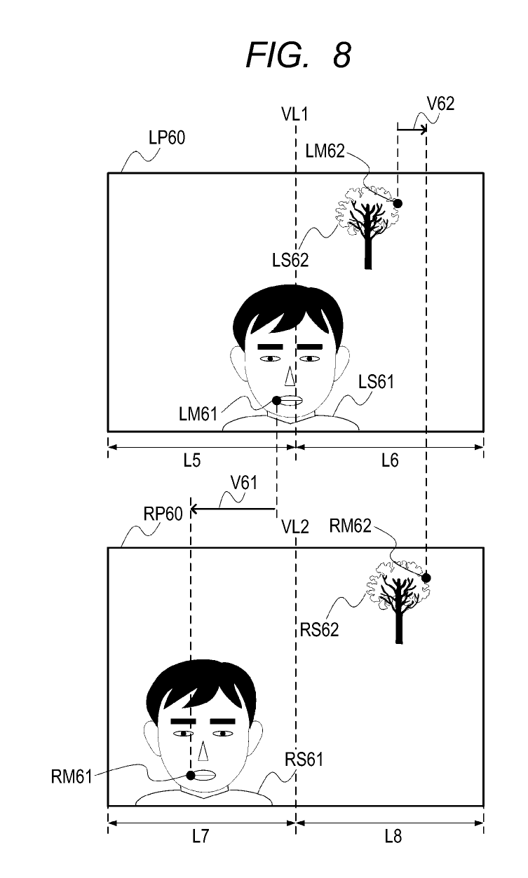

In the case of dividing a 3D-presentation image frame into two areas in the horizontal direction, the parallax-existence-area detector 122 operates as follows. With reference to FIG. 8, the parallax-existence-area detector 122 processes the left-eye image data in the SDRAM 133 to divide the left-eye captured image LP60 into left-hand and right-hand areas along a vertical line VL1. Similarly, the parallax-existence-area detector 122 processes the right-eye image data in the SDRAM 133 to divide the right-eye captured image RP60 into left-hand and right-hand areas along a vertical line VL2.

Preferably, the ROM 131 previously stores reference data representing a prescribed ratio in size between the left-hand and right-hand areas in each of the left-eye and right-eye captured images LP60 and RP60, that is, a prescribed ratio between the horizontal length L5 of the left-hand area and the horizontal length L6 of the right-hand area in the left-eye captured image LP60 and a prescribed ratio between the horizontal length L7 of the left-hand area and the horizontal length L8 of the right-hand area in the right-eye captured image RP60. The prescribed ratio is equal to, for example, 5:5. The parallax-existence-area detector 122 refers to the reference data in the ROM 131, and sets the actual ratio in size between the left-hand and right-hand areas in each of the left-eye and right-eye captured images LP60 and RP60 to the prescribed ratio represented by the reference data.

The CPU 120 may control the parallax-existence-area detector 122 to vary the actual ratio in size between the left-hand and right-hand areas in each of the left-eye and right-eye captured images LP60 and RP60 in accordance with actuation of a button in the operation unit 142 by the user or the viewer. The CPU 120 may control the parallax-existence-area detector 122 to vary the actual ratio in accordance with the number of object pictures to be superimposed or which of the image capturing modes the imaging apparatus 1 is operating in.

With reference to FIG. 8, the parallax-existence-area detector 122 decides which of the left-hand and right-hand areas in the stereo-pair images LP60 and RP60 each of the positional-difference vectors V61 and V62 is contained in. Then, the parallax-existence-area detector 122 concludes that the positional-difference vector V61 between the base point LM61 in the subject picture LS61 in the left-eye captured image LP60 and the corresponding point RM61 in the subject picture RS61 in the right-eye captured image RP60 exists in the left-hand areas of the stereo-pair images LP60 and RP60. Furthermore, the parallax-existence-area detector 122 concludes that the positional-difference vector V62 between the base point LM62 in the subject picture LS62 in the left-eye captured image LP60 and the corresponding point RM62 in the subject picture RS62 in the right-eye captured image RP60 exists in the right-hand areas of the stereo-pair images LP60 and RP60.

Each positional-difference vector between subject pictures in left-eye and right-eye captured images has a horizontal-direction component only. Thus, when a 3D-presentation image frame is divided into left-hand and right-hand areas in the horizontal direction, portions of a positional-difference vector may extend in the left-hand and right-hand areas respectively. In this case, decisions are made as to which of the portions of the positional-difference vector is greater and which of the left-hand and right-hand areas has the greater portion. Then, one of the left-hand and right-hand areas which has the greater portion is concluded to be the area containing the positional-difference vector. When the portions of the positional-difference vector are equal in magnitude (length), each of the left-hand and right-hand areas is concluded to be the area containing the positional-difference vector.

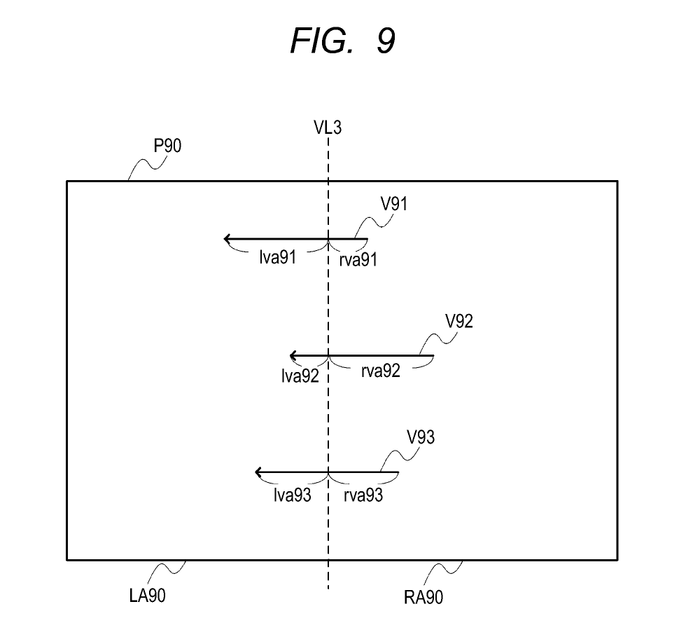

With reference to FIG. 9, a 3D-presentation image frame P90 is divided into a left-hand area LA90 and a right-hand area RA90 in the horizontal direction along a vertical line VL3.

One portion of a positional-difference vector V91 is contained in the left-hand area LA90 and has a magnitude (length) lva91, while the other portion there of is contained in the right-hand area RA90 and has a magnitude (length) rva91. The magnitudes lva91 and rva91 have the following relation.

lva91>rva91

In this case, the parallax-existence-area detector 122 concludes that the positional-difference vector V91 is contained in the left-hand area LA90.

One portion of a positional-difference vector V92 is contained in the left-hand area LA90 and has a magnitude (length) lva92, while the other portion there of is contained in the right-hand area RA90 and has a magnitude (length) rva92. The magnitudes lva92 and rva92 have the following relation.

lva92<rva92

In this case, the parallax-existence-area detector 122 concludes that the positional-difference vector V92 is contained in the right-hand area RA90.

One portion of a positional-difference vector V93 is contained in the left-hand area LA90 and has a magnitude (length) lva93, while the other portion there of is contained in the right-hand area RA90 and has a magnitude (length) rva93. The magnitudes lva93 and rva93 have the following relation.

lva93=rva93

In this case, the parallax-existence-area detector 122 concludes that the positional-difference vector V93 is contained in not only the left-hand area LA90 but also the right-hand area RA90.

A positional-difference vector having portions extending in the left-hand and right-hand areas respectively may be concluded to be contained in both the left-hand and right-hand areas depending on user settings through the operation unit 142, which of the image capturing modes the imaging apparatus 1 is operating in, the number of object pictures to be superimposed, or the types of the object pictures.

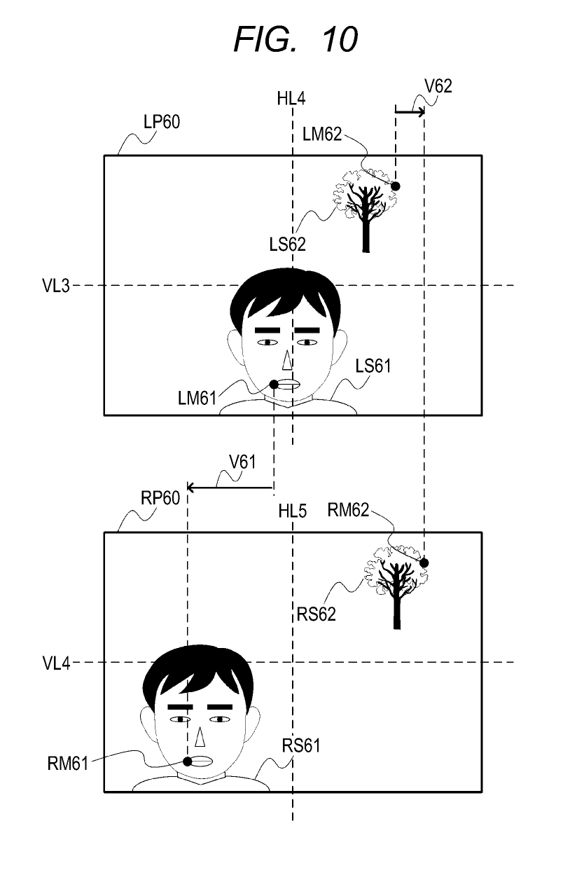

In the case of dividing a 3D-presentation image frame into 2-by-2 areas (two areas in the vertical direction by two areas in the horizontal direction), the parallax-existence-area detector 122 operates as follows. With reference to FIG. 10, the parallax-existence-area detector 122 processes the left-eye image data in the SDRAM 133 to divide the left-eye captured image LP60 into upper-left, upper-right, lower-left, and lower-right areas along a horizontal line VL3 and a vertical line HL4. Similarly, the parallax-existence-area detector 122 processes the right-eye image data in the SDRAM 133 to divide the right-eye captured image RP60 into upper-left, upper-right, lower-left, and lower-right areas along a horizontal line VL4 and a vertical direction HL5.

Preferably, the ROM 131 previously stores reference data representing a prescribed ratio in size among the upper-left, upper-right, lower-left, and lower-right areas in each of the left-eye and right-eye captured images LP60 and RP60. The parallax-existence-area detector 122 refers to the reference data in the ROM 131, and sets the actual ratio in size among the upper-left, upper-right, lower-left, and lower-right areas in each of the left-eye and right-eye captured images LP60 and RP60 to the prescribed ratio represented by the reference data.

The CPU 120 may control the parallax-existence-area detector 122 to vary the actual ratio in size among the upper-left, upper-right, lower-left, and lower-right areas in each of the left-eye and right-eye captured images LP60 and RP60 in accordance with actuation of a button in the operation unit 142 by the user or the viewer. The CPU 120 may control the parallax-existence-area detector 122 to vary the actual ratio in accordance with the number of object pictures to be superimposed or which of the image capturing modes the imaging apparatus 1 is operating in.

With reference to FIG. 10, the parallax-existence-area detector 122 decides which of the upper-left, upper-right, lower-left, and lower-right areas in the stereo-pair images LP60 and RP60 each of the positional-difference vectors V61 and V62 is contained in. Then, the parallax-existence-area detector 122 concludes that the positional-difference vector V61 between the base point LM61 in the subject picture LS61 in the left-eye captured image LP60 and the corresponding point RM61 in the subject picture RS61 in the right-eye captured image RP60 exists in the lower-left areas of the stereo-pair images LP60 and RP60. Furthermore, the parallax-existence-area detector 122 concludes that the positional-difference vector V62 between the base point LM62 in the subject picture LS62 in the left-eye captured image LP60 and the corresponding point RM62 in the subject picture RS62 in the right-eye captured image RP60 exists in the upper-right areas of the stereo-pair images LP60 and RP60.

For a positional-difference vector having portions extending in the upper-left and upper-right areas respectively, decisions are made as to which of the portions of the positional-difference vector is greater and which of the upper-left and upper-right areas has the greater portion. Then, one of the upper-left and upper-right areas which has the greater portion is concluded to be the area containing the positional-difference vector. When the portions of the positional-difference vector are equal in magnitude (length), each of the upper-left and upper-right areas is concluded to be the area containing the positional-difference vector. Similarly, for a positional-difference vector having portions extending in the lower-left and lower-right areas respectively, decisions are made as to which of the portions of the positional-difference vector is greater and which of the lower-left and lower-right areas has the greater portion. Then, one of the lower-left and lower-right areas which has the greater portion is concluded to be the area containing the positional-difference vector. When the portions of the positional-difference vector are equal in magnitude (length), each of the lower-left and lower-right areas is concluded to be the area containing the positional-difference vector.

With reference back to FIG. 5, a step S104 following the step S103 controls the parallax decider 123 to determine a desired parallax between object pictures to be superimposed on the left-eye captured image and the right-eye captured image respectively.

For each area which a computed positional-difference vector or vectors are decided to be contained in by the step S103, the step S104 controls the parallax decider 123 to detect the greatest of the computed positional-difference vectors.

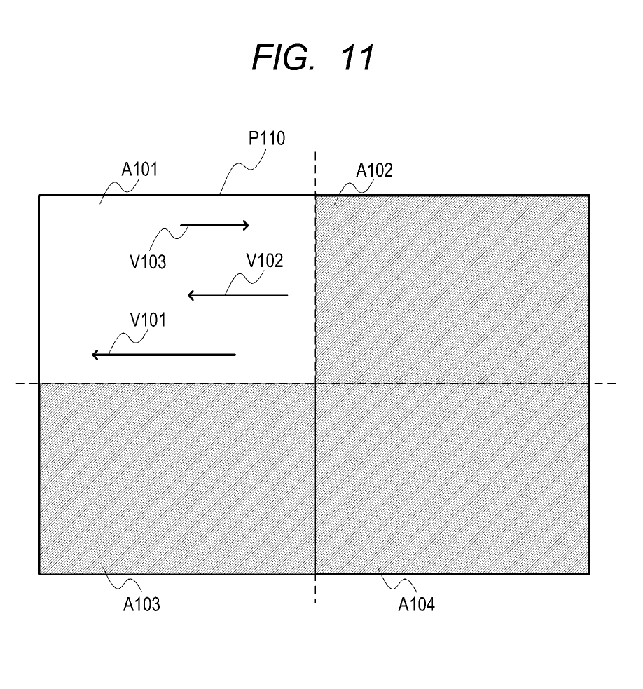

With reference to FIG. 11, a 3D-presentation image frame P110 is divided into an upper-left area A101, an upper-right area A102, a lower-left area A103, and a lower-right area A104. Computed positional-difference vectors V101, V102, and V103 exist in the upper-left area A101. The relation in magnitude (length) among the positional-difference vectors V101, V102, and V103 is as follows.

|V101|>|V102|>51 V103|

In this case, the parallax decider 123 determines that the positional-difference vector V101 is the greatest for the upper-left area A101. For each of the other areas A102, A103, and A104, the parallax decider 123 operates similarly to the above.

For each area, the parallax decider 123 detects the direction and magnitude of the greatest positional-difference vector and determines a parallax between to-be-superimposed object pictures in accordance with the detected direction and magnitude.

When the detected direction of the greatest positional-difference vector is leftward, the base point in the left-eye captured image and the corresponding point in the right-eye captured image have a positional relation as that in FIG. 4(a). In this case, the related subject picture is perceived as a popping-out picture. The parallax decider 123 sets a parallax between stereo-pair object pictures to a positional-difference vector equal in direction and magnitude (length) to the greatest positional-difference vector. Consequently, a resultant object picture indicated near a popping-out subject picture is perceived as one popping out from the screen plane to a degree similar to that of the subject picture. Thus, a burden on viewer's eyes can be reduced.

When the detected direction of the greatest positional-difference vector is rightward, the base point in the left-eye captured image and the corresponding point in the right-eye captured image have a positional relation as that in FIG. 4(c). In this case, the related subject picture is perceived as a standing-back picture. Preferably, the CPU 120 controls the parallax decider 123 to respond to a signal of user's preference inputted in advance by actuation of a button in the operation unit 142. When user's preference is of a first type, the parallax decider 123 sets a parallax between stereo-pair object pictures to a positional-difference vector equal in direction and magnitude (length) to the greatest positional-difference vector. Consequently, a resultant object picture indicated near a standing-back subject picture is perceived as one standing back from the screen plane to a degree similar to that of the subject picture. When user's preference is of a second type different from the first type, the parallax decider 123 sets a parallax between stereo-pair object pictures to zero (a zero positional-difference vector). Consequently, a resultant object picture indicated near a standing-back subject picture is perceived as one located at the screen plane.

Observation of a standing-back picture puts a greater burden on viewer's eyes than observation of a popping-out picture does for the following reason. Moving human pupils outward from their normal positions is more difficult than moving them inward from their normal positions. The user (viewer) can arbitrarily select one from the following first and second ways an object picture near a standing-back subject picture is indicated. In the first way, an object picture near a standing-back subject picture is indicated as one standing back from the screen plane to a degree similar to that of the subject picture. In the second way, an object picture near a standing-back subject picture is indicated as one located at the screen plane. Thus, a burden on viewer's eyes can be reduced.

When the greatest positional-difference vector is zero, the base point in the left-eye captured image and the corresponding point in the right-eye captured image have a positional relation as that in FIG. 4(b). In this case, the related subject picture is perceived as one located at the screen plane. The parallax decider 123 sets a parallax between stereo-pair object pictures to zero. Consequently, a resultant object picture indicated near a subject picture displayed as one located at the screen plane is perceived as one located at the screen plane also. Thus, a burden on viewer's eyes can be reduced.

With reference back to FIG. 5, a step S105 following the step S104 controls the object image superimposer 124 to read out the object picture data and the object picture positional information from the object picture recorder 125 and add the read-out object picture data to the left-eye and right-eye image data in response to the object picture positional information to superimpose the object pictures on the left-eye and right-eye captured images at positions represented by the object picture positional information. Furthermore, the step S105 controls the object image superimposer 124 in response to the parallaxes determined by the step S104 (or the parallax decider 123) so that the actual parallaxes between the superimposed object pictures in stereo-pairs will be equal to the determined parallaxes. Accordingly, the object pictures in each stereo-pair are superimposed on the left-eye and right-eye captured images respectively in a manner such that the actual parallax between the superimposed object pictures is equal to the parallax determined by the step 5104 (or the parallax decider 123).

According to control by the CPU 120, the processed left-eye and right-eye image data which results from the object picture superimposition is stored in the SDRAM 133. The processed left-eye and right-eye image data can be sent from the SDRAM 133 to the VRAM 134 before being transferred therefrom to the liquid-crystal monitor 140 or the external monitor via the input output I/F 139 and the input output terminals 143. Thus, object-picture-added images represented by the processed left-eye and right-eye image data can be indicated on the liquid-crystal monitor 140 or the external monitor as a 3D image or images having a superimposed object picture or pictures. The input output I/F 139 serves as an output section for left-eye and right-eye images having a superimposed object picture or pictures.

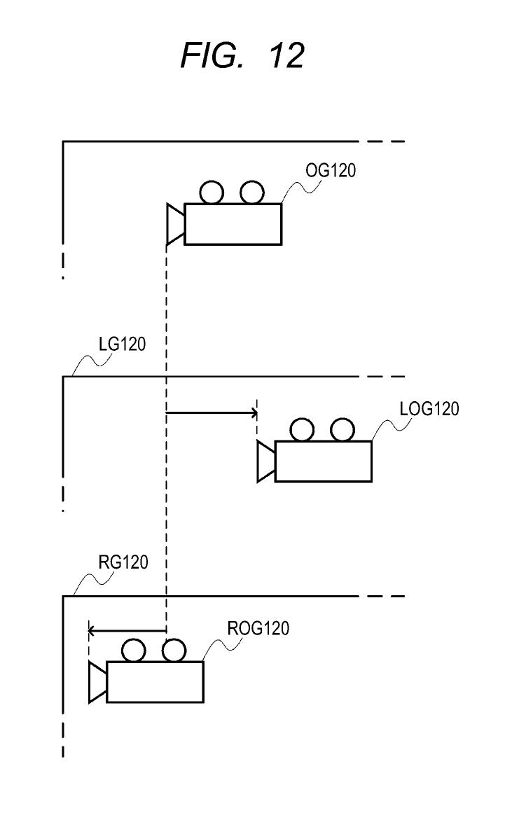

With reference to FIG. 12, the greatest positional-difference vector detected by the step S104 corresponds to a popping-out subject picture. Data representative of an original object picture OG120 is previously stored in the object picture recorder 125. Information representative of a position at which the original object picture OG120 should be superimposed relative to a 3D-presentation image frame is previously stored in the object picture recorder 125 also. Regarding the position information in the object picture recorder 125, an on-frame position at which the original object picture OG120 should be superimposed on a left-eye captured image is the same as an on-frame position at which the original object picture OG120 should be superimposed on a right-eye captured image. Thus, concerning the original object picture OG120, superimposition positions represented by the information in the object picture recorder 125 for left-eye and right-eye captured images are equal to each other.

The object image superimposer 124 functions to shift the original object picture OG120 in response to the related parallax determined by the step S104 (or the parallax decider 123) to generate a left-eye object picture LOG120. Then, the object image superimposer 124 functions to superimpose the left-eye object picture LOG120 on a left-eye captured image LG120. Similarly, the object image superimposer 124 functions to shift the original object picture OG120 in response to the related parallax to generate a right-eye object picture ROG120. Then, the object image superimposer 124 functions to superimpose the right-eye object picture ROG120 on a right-eye captured image RG120.

Specifically, to generate the left-eye object picture LOG120, the object image superimposer 124 shifts the original object picture OG120 rightward by a distance corresponding to half the magnitude |V120| of the related greatest positional-difference vector detected by the step S104 (or the parallax decider 123). Then, the object image superimposer 124 superimposes the left-eye object picture LOG120 on the left-eye captured image LG120. To generate the right-eye object picture ROG120, the object image superimposer 124 shifts the original object picture OG120 leftward by a distance corresponding to half the magnitude |V120| of the related greatest positional-difference vector. Then, the object image superimposer 124 superimposes the right-eye object picture ROG120 on the right-eye captured image RG120. Accordingly, the actual parallax between the left-eye object picture LOG120 and the right-eye object picture ROG120 is equal to the magnitude |V120| of the related greatest positional-difference vector. In this case, the resultant object picture is perceived as a popping-out picture.

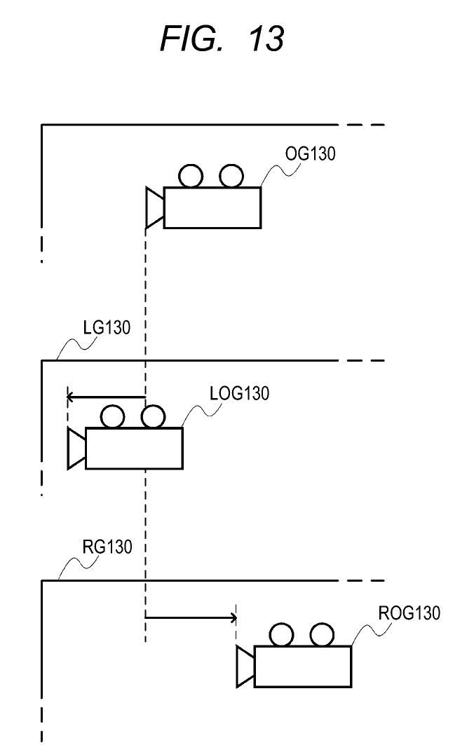

With reference to FIG. 13, the greatest positional-difference vector detected by the step S104 corresponds to a standing-back subject picture. Data representative of an original object picture OG130 is previously stored in the object picture recorder 125. Information representative of a position at which the original object picture OG130 should be superimposed relative to a 3D-presentation image frame is previously stored in the object picture recorder 125 also. Regarding the position information in the object picture recorder 125, an on-frame position at which the original object picture OG130 should be superimposed on a left-eye captured image is the same as an on-frame position at which the original object picture OG130 should be superimposed on a right-eye captured image. Thus, concerning the original object picture OG130, superimposition positions represented by the information in the object picture recorder 125 for left-eye and right-eye captured images are equal to each other.

The object image superimposer 124 functions to shift the original object picture OG130 in response to the related parallax determined by the step S104 (or the parallax decider 123) to generate a left-eye object picture LOG130. Then, the object image superimposer 124 functions to superimpose the left-eye object picture LOG130 on a left-eye captured image LG130. Similarly, the object image superimposer 124 functions to shift the original object picture OG130 in response to the related parallax to generate a right-eye object picture ROG130. Then, the object image superimposer 124 functions to superimpose the right-eye object picture ROG130 on a right-eye captured image RG130.

Specifically, to generate the left-eye object picture LOG130, the object image superimposer 124 shifts the original object picture OG130 leftward by a distance corresponding to half the magnitude |V130| of the related greatest positional-difference vector detected by the step S104 (or the parallax decider 123). Then, the object image superimposer 124 superimposes the left-eye object picture LOG130 on the left-eye captured image LG130. To generate the right-eye object picture ROG130, the object image superimposer 124 shifts the original object picture OG130 rightward by a distance corresponding to half the magnitude |V130| of the related greatest positional-difference vector. Then, the object image superimposer 124 superimposes the right-eye object picture ROG130 on the right-eye captured image RG130. Accordingly, the actual parallax between the left-eye object picture LOG130 and the right-eye object picture ROG130 is equal to the magnitude |V130| of the related greatest positional-difference vector. In this case, the resultant object picture is perceived as a standing-back picture.

When the user has set the parallaxes between stereo-pair object pictures to zero by actuating the button in the operation unit 142, the object image superimposer 124 operates independently of parallaxes between left-eye and right-eye subject pictures. In this case, the object image superimposer 124 uses the original object picture OG130 directly as left-eye and right-eye object pictures LOG130 and ROG130, and functions to superimpose the left-eye and right-eye object pictures LOG130 and ROG130 on the left-eye and right-eye captured images LG130 and RG130 respectively at equal on-frame positions represented by the position information in the object picture recorder 125. Thus, the left-eye and right-eye object pictures LOG130 and ROG130 are indicated at the same position relative to a 3D-presentation image frame so that a resultant object picture is perceived as one located at the monitor screen.

In the case where the greatest positional-difference vector detected by the step S104 (or the parallax decider 123) is a zero vector, the object image superimposer 124 uses an original object picture directly as left-eye and right-eye object pictures, and functions to superimpose the left-eye and right-eye object pictures on left-eye and right-eye captured images respectively at equal on-frame positions represented by the position information in the object picture recorder 125. Thus, the left-eye and right-eye object pictures are indicated at the same position relative to a 3D-presentation image frame so that a resultant object picture is perceived as one located at the monitor screen.

As described above, a 3D-presentation image frame is divided into a plurality of areas. Superimposing stereo-pair object pictures on left-eye and right-eye captured images is controlled in response to the parallaxes between subject pictures on an area-by-area basis. This control is designed so that an object picture indicated near a popping-out subject picture can be perceived as one popping out from the monitor screen, and that an object picture indicated near a standing-back subject picture can be perceived as one standing back from the monitor screen or one located at the monitor screen.

When the user releases the recording button in the operation unit 42 or turns off power to the imaging apparatus 1, the program segment in FIG. 5 ends.

As described above, the imaging apparatus 1 divides a 3D-presentation image frame into a plurality of areas. The imaging apparatus 1 can superimpose object pictures on left-eye and right-eye captured images for 3D presentation. The object picture superimposition is designed so that the degree to which an object picture pops out or stands back will be adjusted in accordance with the parallax between stereo-pair subject pictures in the left-eye and right-eye captured images for each of the areas. Accordingly, it is possible to suppress a difference in feeling of three dimensionality between an object picture and a subject picture indicated near the object picture. Thus, an object picture can be stereoscopically indicated without putting an excessive burden on the viewer.

The parallax between stereo-pair object pictures superimposed on left-eye and right-eye captured images respectively may be equalized to the greatest of positional-difference vectors related to popping-out subject pictures in each of areas constituting a 3D-presentation image frame. In this case, the indicated object picture is always perceived as a popping-out picture.

This invention may be applied to a stationary recording apparatus or an electronic apparatus without a camera. In this case, the above-mentioned signal processing for superimposing object pictures on left-eye and right-eye captured images is implemented during the recording or reproduction of image data representative of the left-eye and right-eye captured images.

What is claimed is:

1. A 3D image processing apparatus comprising:
a recording section configured to record data representative of a first image and data representative of a second image;
an object image store section configured to store data representative of an object image to be superimposed on the first image and the second image;
a parallax calculator configured to calculate a parallax between each subject image in the first image and a corresponding subject image in the second image;
a parallax existence area detector configured to divide a 3D image formed by the first image and the second image into a plurality of areas, and detect which of the areas each parallax calculated by the parallax calculator is present in;
a parallax decider configured to determine a desired parallax between the object image to be superimposed on the first image in one of the areas and the object image to be superimposed on the second image in said one of the areas on the basis of the calculated parallax or parallaxes present in said one of the areas;
an object image superimposer configured to superimpose the object image on the first image and the second image in said one of the areas in a manner such that a parallax between the object image superimposed on the first image and the object image superimposed on the second image will be equal to the desired parallax determined by the parallax decider; and
an output section configured to output the first image with the superimposed object image and the second image with the superimposed object image as a 3D image.

2. A 3D image processing apparatus as recited in claim 1, wherein the parallax decider determines the desired parallax so that the desired parallax will be equal to the greatest of the calculated parallaxes present in said one of the areas.

3. A 3D image processing apparatus as recited in claim 1, wherein the parallax decider determines the desired parallax so that the desired parallax will be equal to the greatest of the calculated parallaxes present in said one of the areas in cases where the greatest of the calculated parallaxes corresponds to a popping-out subject image, and the parallax decider determines the desired parallax so that the desired parallax will be equal to zero or the greatest of the calculated parallaxes present in said one of the areas in cases where the greatest of the calculated parallaxes corresponds to a standing-back subject image.

4. A 3D image processing apparatus as recited in claim 3, wherein the parallax existence area detector divides the 3D image formed by the first image and the second image into at least two areas in a horizontal direction or a vertical direction.

5. A method of processing 3D image, comprising the steps of:
recording data representative of a first image and data representative of a second image;
calculating a parallax between each subject image in the first image and a corresponding subject image in the second image;
dividing a 3D image formed by the first image and the second image into a plurality of areas;
detecting which of the areas each calculated parallax is present in;
determining a desired parallax between an object image to be superimposed on the first image in one of the areas and the object image to be superimposed on the second image in said one of the areas on the basis of the calculated parallax or parallaxes present in said one of the areas;
superimposing the object image on the first image and the second image in said one of the areas in a manner such that a parallax between the object image superimposed on the first image and the object image superimposed on the second image will be equal to the desired parallax; and
outputting the first image with the superimposed object image and the second image with the superimposed object image as a 3D image.

6. A method as recited in claim 5, wherein the determining step comprises determining the desired parallax so that the desired parallax will be equal to the greatest of the calculated parallaxes present in said one of the areas.

7. A method as recited in claim 5, wherein the determining step comprises determining the desired parallax so that the desired parallax will be equal to the greatest of the calculated parallaxes present in said one of the areas in cases where the greatest of the calculated parallaxes corresponds to a popping-out subject image, and determining the desired parallax so that the desired parallax will be equal to zero or the greatest of the calculated parallaxes present in said one of the areas in cases where the greatest of the calculated parallaxes corresponds to a standing-back subject image.

8. A method as recited in claim 7, wherein the dividing step comprises dividing the 3D image formed by the first image and the second image into at least two areas in a horizontal direction or a vertical direction.
